(19) United States
(12) Patent Application Publication
(10) Pub. No.: US 2026/0357479 A1
(43) Pub. Date: Nov. 12, 2026

(54) MELT-BLENDABLE COMPOSITIONS FOR GENERATING HYDROPHOBIC SURFACES IN NONWOVENS

(71) Applicant: TECHMER PM, LLC, Clinton, TN (US)

(72) Inventors: Bhushan Janardan DESHPANDE, Clinton, TN (US); Kaan SERPERSU, Clinton, TN (US); McKenzie NORMAN, Clinton, TN (US)

(73) Assignee: TECHMER PM, LLC, Clinton, TN (US)

(21) Appl. No.: 19/714,249

(22) Filed: Jun. 19, 2026

Related U.S. Application Data
(63) Continuation of application No. PCT/US2024/061418, filed on Dec. 20, 2024.
(60) Provisional application No. 63/612,770, filed on Dec. 20, 2023.

(51) Int. Cl. D01F 1/10; C08G 77/04; C08K 3/22; C08K 5/103; D01D 1/02; D01D 5/098; D04H 1/56; D04H 3/16

(52) U.S. Cl. CPC D01F 1/10; C08G 77/04; C08K 3/22; C08K 5/103; D01D 1/02; D01D 5/0985; D04H 1/56; D04H 3/16; C08K 2003/2227; D10B 2401/021

(57) ABSTRACT

Fluorine-free compositions and methods for producing a non-woven fiber and/or fabric capable of repelling low surface tension fluids. Compositions may include a siloxane-based component, an aluminum-oxide based component, a triglyceride, and a resin. A masterbatch composition when blended as an additive into a base resin may lower the surface tension of a produced fibers which may increase barrier properties of a nonwoven fabric prepared from the fiber. The nonwoven fabric may serve as a barrier material for low surface tension fluids including but not limited to bodily fluids. No fluorine based components may be used or added during production of the masterbatch composition, or during production of the blend, fiber, or fabric using the masterbatch composition.

### CROSS REFERENCE TO RELATED APPLICATIONS

This application is a continuation of International patent application no. PCT/US2024/061418 filed Dec. 20, 2024, which claims the benefit of U.S. provisional Application no. 63/612,770 filed Dec. 20, 2023, which are incorporated herein by reference in their entireties.

### TECHNICAL FIELD

The present disclosure generally relates to the use of siloxane-based melt-blendable additives for generating hydrophobic surfaces in nonwoven fabric manufacturing.

### BACKGROUND

Nonwoven fabrics are often used to provide a barrier to low surface tension fluids, including contaminated bodily fluids. Historically, a coating or film was applied to nonwoven fabrics to induce fluid repellency of low surface tension fluids. These coatings or films often included fluorinated and silicone-based components. Fluorinated coatings, however, are harmful to both the environment and to human health, and silicone components are difficult to apply to nonwoven surfaces. As such, there is a need for fluorine-free compositions that are melt-blendable that produce fibers and/or fabrics capable of repelling low surface tension fluids.

### SUMMARY

In at least an aspect, a masterbatch composition is provided. The masterbatch composition may comprise 5 to 30 wt % of a siloxane-based component; 5 to 50 wt % of an aluminum oxide-based component; 5 to 30 weight % of a triglyceride; and 40 to 80 wt % of a carrier resin based on the total weight of the masterbatch composition.

In at least another aspect, a blend is provided. The blend may comprise 3 to 20 wt % of a masterbatch composition including a siloxane-based component, an aluminum oxide-based component, a triglyceride, and a carrier resin, and 80 to 97 wt % of a base resin.

In yet another aspect, a fiber capable of repelling low surface tension fluids is provided. The fiber may comprise 3 to 20 wt % of a masterbatch composition including 5 to 30 wt % of a siloxane-based component; 5 to 50 wt % of an aluminum oxide-based component; 5 to 30 weight % of a triglyceride; and 40 to 80 wt % of a carrier resin based on the total weight of the masterbatch composition. The fiber may also comprise 80 to 97 wt % of a base resin.

### DETAILED DESCRIPTION

Reference will now be made in detail to presently preferred compositions, embodiments and methods of the present disclosure, which constitute the best modes of practicing the disclosure presently known to the inventors. The Figures are not necessarily to scale. However, it is to be understood that the disclosed embodiments are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R′ and R″′ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{( 0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “extruder” as used herein means a machine used to extrude viscous substances, including but not limited to polymers, into high quality structured products by controlling the processing conditions.

The term “extrusion” as used herein means the process of forcing melted polymer pellets or granules through a die with an opening.

Throughout this application, where publications are referenced, the disclosures of these publications in their entireties are hereby incorporated by reference into this application to more fully describe the state of the art to which this disclosure pertains.

The following examples illustrate the various embodiments of the present disclosure. Those skilled in the art will recognize many variations that are within the spirit of the present disclosure and scope of the claims.

Nonwoven textiles are materials that are similar to fabrics but are neither woven nor knitted. Nonwovens are generally made from staple fibers which are short fibers, and longer fibers called continuous long fibers. These fibers may be bonded together using either chemical, mechanical, heat or solvent treatments for example.

Nonwoven fabrics may for example be produced by the spun bonding method. This method may include for example melt spinning to deposit fibers as a net. The fibers in the net may then be bonded using chemical, mechanical, or thermal bonding methods. Thermal point bonding in which heat and pressure are used to bond the net fibers together at particular points along and across the net is commonly used.

Nonwoven fabrics may also be produced by melt blowing. This method may include extruding a polymer melt through small nozzles to form a randomly deposited sheet of a mixture of micro and nano fibers. High speed high temperature air is used to blow the extruded fibers together and toward a collection screen. Thermal bonding may be used to bond sheets together or to bond melt-blown sheets to spun-bond layers.

Nonwoven fabrics are often used to provide a barrier to low surface tension fluids, including contaminated bodily fluids. Historically, a coating or film was applied to nonwoven fabrics to induce fluid repellency of low surface tension fluids.

The coatings or films historically used to provide fluid resistance to the surfaces of nonwovens often included fluorinated and silicone-based components. Fluorinated coatings, however, are harmful to both the environment and to human health, and silicone components are difficult to apply to nonwoven surfaces. As such, there is a need for fluorine-free compositions that are melt-blendable that produce fibers and/or fabrics capable of repelling low surface tension fluids.

Fluoropolymers and fluoroelastomers are part of the group of compounds known as perfluoroalkyl and polyfluoroalkyl substances (PFAS). PFAS can be formed during manufacturing processes. For example, in 2021, PFOA was found to be unintentionally produced when high-density polyethylene containers used to store pesticides were fluorinated. In this way, many fluorine-containing compounds have the potential to produce PFAS. Given that PFAS have been found to be harmful to both the environment and to human health, manufacturers are seeking ways to phase out the use of fluorine-containing compounds.

Siloxane is a functional group having an inorganic backbone with the silicon-oxygen-silicon (Si—O—Si) linkage. Each silicon atom may carry two organic groups, typically methyl, ethyl, or phenyl groups. Siloxane polymers are called silicones. Siloxane polymers are ubiquitous in the modern world as they are components of many consumer products including pharmaceutical products, lotions and shampoos. Siloxane polymers can also be found in polyurethane cushions, paints and coatings, nautical sealants, aerospace equipment, dielectric barriers, and even cooking oil.

In at least an embodiment, a masterbatch composition is provided for use in manufacturing a nonwoven fiber or fabric to provide a hydrophobic surface on the fiber or fabric. The master batch may include a siloxane-containing component, an aluminum oxide-containing component, a triglyceride, a carrier resin and optional components including antioxidant, antistat, colorant system and polybutene-1 to control migration. The siloxane-based component in at least an embodiment may comprise an organo-modified siloxane. The aluminum oxide-containing component in at least an embodiment may comprise a fumed metal oxide. In an example, the aluminum oxide-based component may comprise silane, trimethoxyoctyl-, reaction products with aluminum oxide. The triglyceride in at least an embodiment may comprise three fatty acids connected to a glycerol. The fatty acids may be obtained from vegetable, animal, and/or synthetic sources. For example, octadecanoic acid, also called stearic acid, may be derived from animal fat and oils or from vegetable oils including palm or sunflower oil. The stearic acid may also be prepared by hydrogenation of vegetable oils, such as cottonseed oil. The triglyceride in at least an embodiment may comprise three stearic acid molecules. The triglyceride in at least an embodiment may comprise glyceryl tristearate. The glycerol tristearate may have a surface energy of 34.2 mJ/m2. The triglyceride in at least an embodiment may comprise glycerol trioleate. The triglyceride may comprise glycerol esters with 12-30 carbons. The carrier resin may be a polymer. In at least an embodiment, the carrier resin may comprise polypropylene for example. The polypropylene may have a surface energy ranging from 29.4 to 30.1 mJ/m². In at least an embodiment, the polypropylene carrier resin when utilized in spun bonding applications may have a melt flow rate as measured by ASTM D1238 ranging from 15 to 50. In an example, the polypropylene carrier resin may have a melt flow rate of 20 to 45, or of 25 to 35. In at least an embodiment, the polypropylene carrier resin when utilized in melt-blown applications may have a melt flow rate of 800 to 2000, or of 1000 to 1900, or of 1200 to 1800. Non-limiting examples of polypropylenes may include a syndiotactic polypropylene, an atactic polypropylene, a metallocene-based polypropylene, a single-site-catalyst-derived polypropylene, and/or a constrained-geometry-catalyst-derived polypropylene. It is recognized that the polypropylene may be a homopolymer or a copolymer without exceeding the scope of this disclosure. Non-limiting examples of copolymers include block copolymers, graft copolymers, random copolymers, and alternating copolymers. A modifying polymer that may comprise a portion of the copolymer may include acrylic compounds such as methacrylates; ionmeric compounds; or other thermoplastics, such as a polyamide without exceeding the scope of the disclosure.

In at least an embodiment, the siloxane-based component may range from 5 to 30 wt % of the total weight of the masterbatch. In other embodiments, the siloxane-based component may range from 10 to 25 wt. % of the total weight of the masterbatch. In at least an embodiment, the siloxane-based component may range from 15 to 20 wt. % of the total weight of the masterbatch.

In at least an embodiment, the aluminum oxide-based component may range from 5 to 50 wt. % of the total weight of the masterbatch. In other embodiments, the aluminum oxide-based component may range from 10 to 45 wt. % of the total weight of the masterbatch. In at least an embodiment, the aluminum oxide-based component may range from 30 to 40 wt. % of the total weight of the masterbatch.

In at least an embodiment, the triglyceride may range from 5 to 30 wt % of the total weight of the masterbatch. In other embodiments, the triglyceride may range from 10 to 25 wt. % of the total weight of the masterbatch. In at least an embodiment, the triglyceride may range from 15 to 20 wt. % of the total weight of the masterbatch.

In at least an embodiment, the carrier resin may range from 5 to 95 wt. % of the total weight of the masterbatch. In other embodiments, the carrier resin may range from 40-85 wt. % of the total weight of the masterbatch. In at least an embodiment, the carrier resin may range from 60-80 wt. % of the total weight of the masterbatch.

In at least an embodiment, the masterbatch composition may comprise 5 to 30 wt % of a siloxane-based component, 10 to 50 wt. % of an aluminum oxide-based component, 5 to 30 wt % of a triglyceride, and 5 to 95 wt % of a carrier resin. In another embodiment, the masterbatch composition may comprise about 18 to 22 wt. % of a siloxane-based component, 35 to 45 wt. % of an aluminum oxide-based component, 18 to 22 wt. % of a triglyceride, and 5 to 40 wt. % carrier resin. It is recognized that in some embodiments, the masterbatch composition may comprise any of the siloxane-based component, the aluminum oxide-based component, or the triglyceride alone or in combination with any other component. Optionally, the masterbatch composition may additionally comprise up to 1 wt. % of an antioxidant, 5 to 20 wt. % of polybutene-1, up to 3 wt. % of an antistat, and up to 3 wt. % of a colorant system.

To generate the masterbatch composition, the components may be mixed together and heated. The mixture may then be extruded using an extruder, for example. The extruded mixture may then be cooled and formed into flakes, granules, powders, pellets, or other suitable masterbatch forms for use in applications including but not limited to extrusion, spun bonding, and/or melt blowing.

In at least an embodiment, the masterbatch composition may be formed into a pellet. The pellet size of the masterbatch composition measured by pellets per gram (PPG) may range from about 40 to 100, or from about 42 to 90 or from about 45 to 65 PPG. The pellet may have a melt flow rate as measured by ASTM D1238 of 35 to 100, or of 45 to 65 for spunbond applications, or of 800 to 1800, or of 1000 to 1700, or of 1200 to 1600 for melt-blown applications.

In at least an embodiment, a blend is provided for use in manufacturing a nonwoven fiber or fabric to provide a hydrophobic surface on the fiber or fabric. The blend may include the masterbatch, which includes a siloxane-based component, an aluminum oxide-based component, a triglyceride, a carrier resin, a base resin, and other optional components including antistat and colorant systems. In at least an embodiment, the masterbatch may be added to a base resin at a letdown ratio ranging from 3 to 20 wt %, based on the total weight of the blend. For example, the masterbatch may be added to a base resin at about 3, 4, 5, 6, 7, 8, 9, 10, 11, 12, 13, 14, 15, 16, 17, 18, 19, or 20 wt %. In other embodiments, the masterbatch may be added to a base resin at a letdown ratio ranging from 5 to 15% or from 7 to 10 %. A letdown ratio of 5% for example, means that the blend contains 5% of the masterbatch and 95% of the base resin.

In at least an embodiment, the base resin may comprise a polymer. In at least an embodiment, the base resin may comprise polypropylene. The base resin may have a relatively narrow molecular weight distribution that allows a relatively higher draw ratio when extruded through a plurality of fine, usually circular, die capillaries as molten threads or filaments. In an example, the base resin may have a melt flow rate as measured by ASTM D1238 of 20 to 45, or of 25 to 35 for spunbond applications. In at least an embodiment, the base resin when utilized in melt-blown applications may have a melt flow rate of 800 to 1800, or of 1000 to 1700, or of 1200 to 1600.

To generate the blend, the components may be mixed together and heated. The mixture may then be extruded using an extruder, for example. The extruded mixture may then be cooled and formed into flakes, granules, powders, pellets, or other suitable masterbatch forms for use in applications including but not limited to extrusion, spun bonding, and/or melt blowing.

In at least an embodiment, the siloxane-based component may range from 1 to 5 wt. % of the total weight of the blend. In other embodiments, the siloxane-based component may range from 2-4 wt. % of the total weight of the blend. In at least an embodiment, the siloxane-based component may range from 2.5-3.5 wt. % of the total weight of the blend.

In at least an embodiment, the aluminum oxide-based component may range from 1 to 5 wt % of the total weight of the blend. In other embodiments, the aluminum oxide-based component may range from 2-4 wt. % of the total weight of the blend. In at least an embodiment, the aluminum oxide-based component may range from 2.5-3.5 wt. % of the total weight of the blend.

In at least an embodiment, the triglyceride may range from 1 to 20 wt. % of the total weight of the blend. In other embodiments, the triglyceride may range from 2-15 wt. % of the total weight of the blend. In at least an embodiment, the triglyceride may range from 2-4 wt. % of the total weight of the blend.

In at least an embodiment, the blend may be formed into a pellet. The pellet size of the masterbatch composition measured by pellets per gram (PPG) may range from about 40 to 100, or from about 42 to 90 or from about 45 to 65 PPG. The pellet may have a melt flow rate as measured by ASTM D1238 of 35 to 100, or of 45 to 65 for spunbond applications, or of 800 to 1800, or of 1000 to 1700, or of 1200 to 1600 for melt-blown applications.

In at least an embodiment, the masterbatch may be added to a base resin suitable for making a fiber and melt blended to produce a nonwoven fiber, such as a spun-bonded fiber, a meltblown fiber, or other types of fibers. The masterbatch, when blended as an additive into the base resin, lowers the surface tension of the produced fibers which increases the barrier properties of a nonwoven fabric prepared from the resulting fibers. The resulting nonwoven fabric may serve as a barrier material for low surface tension fluids including but not limited to bodily fluids. The non-woven fabric contains substantially no fluorine-based or other halogen-based chemicals derived from the fibers. No fluorine based components may be used or added during production of the masterbatch composition, or during production of the blend, fiber, or fabric using the masterbatch composition. In at least an embodiment, the masterbatch may be added to a base resin suitable for making a fiber and melt blended to produce a nonwoven fiber such as a continuous fiber (CF), a bulk continuous fiber (BCF), a partially oriented yarn (POY), a fully oriented yarn (FOY) of 1-35 denier per filament (DPF), or a staple fiber of cut length 0.25-4 and a total denier of 1-600. Continuous and bulk continuous fibers may also be referred to as continuous and bulk continuous filaments. FOY may also be referred to as fully drawn yarn (FDY).

In at least an embodiment, fabric produced using the master batch composition or the blend may have a weight ranging from 8-100 g/m². In other embodiments, fabric produced using the master batch composition may have a weight ranging from 10-60 g/m². In at least an embodiment, fabric produced using the master batch composition may have a weight ranging from 15-45 g/m² of the total weight of the masterbatch. In at least an embodiment, fabric produced using the master batch composition or the blend may be a spunbond nonwoven having a weight ranging from 8-200 g/m². In other embodiments, fabric produced using the master batch composition or the blend may be a meltblown nonwoven having a weight ranging from 4-35 g/m².

In at least an embodiment, fabric produced using the master batch composition or the blend may achieve a rating of at least 3 in the standard alcohol repellency test described by the Association of the Nonwoven Fabrics Industry (INDA) IST 80.8. A rating of 3 signifies that the fabric is impermeable to a mixture of 30% water and 30% isopropyl alcohol for at least five minutes. Fabric that is not treated with the masterbatch composition or blend may achieve an alcohol repellency rating of about 2. In at least an embodiment, fabric produced using the master batch composition or blend may achieve an alcohol repellency rating ranging from 3 to 10, or from 7 to 9.

In at least an embodiment, fabric produced using the master batch composition may have a contact angle ranging from 90° to 110° or from 92° to 105° or from 94° to 100° when measured according to test method ASTM D2578. Spun-bonded fibers produced using a master batch composition according to at least an embodiment may generally be smaller than 50 μm in average diameter. In another embodiment, spun-bonded fibers range in average diameter from 1 μm to 25 μm. In a further embodiment, spun-bonded fibers range in average diameter from 8 μm to 23 μm. In yet another embodiment spun-bonded fibers range in average diameter from 12 μm to 20 μm.

Meltblown fibers produced, using the masterbatch according to an embodiment, in a meltblown web or layer may have a number-average fiber diameter ranging from 1 μm to 5 μm. In another embodiment, the meltblown fibers may have a number-average fiber diameter ranging from 1 μm to 4 μm. In yet another embodiment, the meltblown fibers may have a number-average fiber diameter ranging from 1 μm to 3 μm.

Melt-blown fibers of one or more of the webs or layers may include nanofibers, having a diameter of less than 1000 nanometers. In at least an embodiment, a layer or web containing nanofibers may consist exclusively of nanofibers. In another embodiment, the layer containing nanofibers may be mixed with fibers of a larger diameter.

Nonwoven fabric produced by spun-bonded fibers when including the masterbatch may be a single-ply fabric such as a spun-bonded sheet (S), a meltblown sheet (M), or a laminate having multiple layers. For example, the nonwoven fabric produced may be a spun-bonded layer-spun-bonded layer (SS), a spun-bonded layer-spun-bonded layer-spun-bonded layer (SSS), a spun-bonded layer-meltblown layer (SM), or a spun-bonded layer-meltblown layer-spun-bonded layer (SMS) laminate. The laminate may be of either a balanced or an unbalanced structure. Additional non-limiting examples of laminates may include spun-bonded layer-meltblown layer-meltblown layer-spun-bonded layer (SMMS), spun-bonded layer-meltblown layer-meltblown layer-spun-bonded layer-spun-bonded layer (SMMSS), or spun-bonded layer-meltblown layer-meltblown layer-meltblown layer-spun-bonded layer (SMMMSS).

It is recognized that the bonding pattern for fabric, such as an SMS, SMMS, or SMMSS laminate for example, produced using the master batch composition or blend may be chosen based on the characteristics required by a particular application. For example, the bonding pattern may affect fabric properties such as tensile strength and fiber structure.

The spun-bonded and/or meltblown fabric may be suitable for forming into a medical, filtration, hygiene, and/or industrial product. Non-limiting examples of medical products include personal protective gear including gowns, caps, and/or face masks, patient hospital gowns, wound patches, sterilization bandages, and/or filtration fabrics. Non-limiting examples of hygiene products include clothing, medical coverings, and/or personal care sanitary articles including diapers. Non-limiting examples of filtration products include products utilized for filtering liquids, gases, and/or bacteria for example. The spun-bonded and/or meltblown fabric may be used to form personal protective equipment that may be utilized in any field including but not limited to medicine, biological or chemical research and design, construction, or hazardous waste cleanup.

The surface energy of a fabric produced from meltblending the masterbatch with a base resin may have a hydrohead ranging from 10 inches of water to 20 inches of water when measured according to method IST 80.6(0.01 ) according to at least an embodiment. In another embodiment, the hydrohead may range from 12 inches of water to 18 inches of water. In yet another embodiment, the hydrohead may range from 14 inches of water to 16 inches of water.

The energy required to break a nonwoven fabric or fiber produced using the masterbatch, called the tensile energy adsorption or TEA, may be measured by method ASTM D1682. In at least an embodiment, the fabric or fiber may have a TEA ranging from 1500 g/inch² to 6500 g/inch². In another embodiment, fabric or fiber may have a TEA ranging from 2000 g/inch² to 5500 g/inch².

What is claimed is:

1. A masterbatch composition comprising:
5 to 30 wt % of a siloxane-based component;
5 to 50 wt % of an aluminum oxide-based component;
5 to 30 weight % of a triglyceride; and
40 to 80 wt % of a carrier resin based on the total weight of the masterbatch composition.

2. The masterbatch composition of claim 1, wherein the masterbatch composition does not include a fluorine-based component.

3. The masterbatch composition of claim 1, wherein the siloxane-based component is an organo-modified siloxane.

4. The masterbatch composition of claim 1, wherein the aluminum oxide-based component is a fumed metal oxide.

5. The masterbatch composition of claim 1, wherein the triglyceride comprises glyceryl tristearate.

6. The masterbatch composition of claim 1, wherein the carrier resin has a melt flow rate as measured by ASTM D1238 ranging from 15 to 50 g/10 min.

7. The masterbatch composition of claim 1, wherein the carrier resin has a melt flow rate as measured by ASTM D1238 ranging from 800 to 2000 g/10 min.

8. The masterbatch composition of claim 1, further comprising 5 to 20 wt % of polybutene-1.

9. A blend comprising:
3 to 20 wt % of a masterbatch composition including a siloxane-based component, an aluminum oxide-based component, a triglyceride, and a carrier resin, and 80 to 97 wt % of a base resin.

10. The blend of claim 9, wherein the masterbatch composition comprises:
5 to 30 wt % of a siloxane-based component;
5 to 50 wt % of an aluminum oxide-based component;
5 to 30 weight % of a triglyceride; and
40 to 80 wt % of a carrier resin based on the total weight of the masterbatch composition.

11. The blend of claim 10, wherein the blend does not include a fluorine-based component.

12. The blend of claim 11, wherein the siloxane-based component ranges from 1 to 5 wt. % of the total weight of the blend.

13. The blend of claim 12, wherein the aluminum oxide-based component ranges from 1 to 5 wt % of the total weight of the blend.

14. The blend of claim 13, wherein the triglyceride ranges from 1 to 20 wt. % of the total weight of the blend.

15. A fiber capable of repelling low surface tension fluids comprising:
3 to 20 wt % of a masterbatch composition including:
5 to 30 wt % of a siloxane-based component;
5 to 50 wt % of an aluminum oxide-based component;
5 to 30 weight % of a triglyceride; and
40 to 80 wt % of a carrier resin based on the total weight of the masterbatch composition; and
80 to 97 wt % of a base resin.

16. The fiber of claim 15, wherein the fiber does not include a fluorine-based component.

17. The fiber of claim 16, wherein the fiber may be used to produce a fabric capable of repelling low surface tension fluids, and wherein the fabric achieves a rating of at least 3 in the standard alcohol repellency test described by the Association of the Nonwoven Fabrics Industry (INDA) IST 80.8, and wherein the fabric has a contact angle ranging from 90° to 110°.

18. A method of making a fluid resistant nonwoven material comprising:
melt-blending 3 to 20 wt % of the masterbatch of claim 1 and 80 to 97 wt % of a base resin together to form a mixture;
heating the mixture to blend the masterbatch composition and the base resin;
subjecting the mixture to shear stress;
cooling the mixture; and
forming the mixture into a sheet.

19. A method of making a fluid resistant nonwoven material comprising:
melt-blending 3 to 20 wt % of the masterbatch of claim 1 and 80 to 97 wt % of a base resin together to form a mixture;
heating the mixture to blend the masterbatch composition and the base resin;
subjecting the mixture to a shear stress;
extruding the mixture into fibers; and
layering the fibers to form a sheet.

20. A fabric capable of repelling low surface tension fluids, the fabric comprising
the fiber of claim 15.

21. The fabric of claim 20, wherein the fabric achieves a rating of at least 3 in the standard alcohol repellency test described by the Association of the Nonwoven Fabrics Industry (INDA) IST 80.8.

22. The fabric of claim 21, wherein the fabric has a contact angle ranging from 90° to 110°.
